(19) United States
(12) Patent Application Publication
(10) Pub. No.: US 2021/0238835 A1
(43) Pub. Date: Aug. 5, 2021

(54) DRAIN PIPE CLEANING APPARATUS

(71) Applicant: Greg Hall, Paducah, KY (US)

(72) Inventor: Greg Hall, Paducah, KY (US)

(21) Appl. No.: 16/779,407

(22) Filed: Jan. 31, 2020

(51) Int. Cl. E03C 1/30; B08B 9/032; B08B 9/043; B08B 9/045; E03C 1/304; E03C 1/302

(52) U.S. Cl. CPC E03C 1/30; B08B 9/0321; E03C 1/302; B08B 9/045; E03C 1/304; B08B 9/0436

(57) ABSTRACT

The present invention is an pipe cleaning device which can be inserted into a drain pipe and coupled to the sink drain by removing the trap. The device includes an access port and a deflector tube coaxially held within a tee coupling attaching to the drain pipe providing a restriction creating turbulence and a surge of fluid in order to remove scum and algae build up which accumulates on the upper surface of a drain pipe above the water level.

### TECHNICAL FIELD

The present invention relates to the field of devices used to remove mold and algae buildup from difficult to reach areas of a wall drain line connecting to a drain pipe from a trap under a sink.

### BACKGROUND OF THE INVENTION

A sink trap is a loop of pipe extending downward from a drain which is intended to retain water for the purpose of keeping sewer gases from rising out of the sink drain. Clogged drain traps are a common occurrence because solids settle in the trap and become congested there, thus causing a backup or preventing the draining of a sink. A snake or other conventional line cleaning apparatus is typically used to dislodge accumulations in the trap.

One method of cleaning the pipe and/or a clogged trap includes extending a mechanical ‘snake’ which is a flexible device like a cable, into the drain pipe and forcing the distal end of it down through the trap. Some times chemicals can reduce the clog to a more flow-able liquid, or simply removing the trap and cleaning it out.

Conventional apparatus for removing clogs from pipes include U.S. Pat. No. 5,421,904 by Carlson which teaches a perpendicular drain pipe spray nozzle assembly within the drain pipe. U.S. Pat. No. 3,937,404 by Johnson teaches a flexible drain cleaner insertable through the drain. U.S. Pat. No. 4,321,712 by Dixon teaches a decreasing apparatus using a hose coupled to the trap. U.S. Patent Application Publication No. 20080276392 by Schultz teaches a flexible drain cleaner which enters through the drain, sealing same, and includes a flanged distal end. U.S. Pat. No. 3,526,547 teaches a non-flexible pipe piercing through and into the drain pipe just above the trap loop and temporarily connected to a faucet. Often cleaning of the trap fails to solve the clogged drain problem.

however, accumulation of solids in the lines flowing from the trap to the drain are typically not accessible

Over a period of time of several years, the water in a drain pipe draining from a sink creates a moist environment whereby condensation collects on the inside top surface of the drain pipes which facilitate the growth or algae and fungi. The sticky and fibrous material adheres to the top surface and sidewalls of the pipes above the level of the water draining through the pipe because the flow of water in the pipe is inadequate to completely fill the pipe and scour or purge the growth of algae and scale from the upper inner surface of the pipe.

The slightly downward tilted sink drawn pipe following after the trap connects to another slightly downward tilted wall drain pipe in the wall. The bottom halves of both of these pipes are usually fairly clean because of the frequent water flow. However, the upper half of these pipes stays moist, but the periodic flow of water through the pipe is not sufficient to remove algae and scum buildup in the discharge pipe. The organic material grows to create filaments or form mats partially blocking or restricting flow in the top half of the pipe. Solids such as food particles, trash, hair retained in the sink water can catch on the algae or scum and cause a clog. The sink drain must be open to use a mechanical snake, thus requiring the removal of part of the drain such as the drain plug and stem. Chemicals can degrade the pipes and pollute the environment. Moreover, the flow of water does not produce enough volume to completely fill the pipes so chemical drain cleaners will not contact and remove deposits of algae or other deposits on the top inner surface of the drain pipes to remove the material restricting the pipe flow. There is no simple and easy solution for cleaning such scum from the pipes.

### SUMMARY OF THE INVENTION

The pipe cleaner apparatus may be installed upon constructions or installed as a kit for permanent or temporary installation to a trap unit under a sink.

The instant invention comprises a pipe cleaning device which can be coupled to the sink drain by replacing a conventional 90 degree tee pipe coupling or elbow connecting the sink drain pipe to the drain pipe in the wall with an elbow having a angled access port to accept a brush, snake, or water wand or connect to a water line or other line for injecting water and/or soap or other detergent or other cleaning solution there through. The offset access fitting (spout or short conduit) has a removable plug extending at a selected angle from the distal end of a downward extending elbow of a straight segment of conduit connecting the trap to the deflector tee conduit for insertion of a line cleaning means such as a retractable and rotatable brush and/or nozzle from a pressurized fluid line.

The pipe cleaning kit includes a straight pipe portion including a deflector tee conduit connecting to the modified elbow including the access port and is inserted into the drain line. The deflector means attaches to the inner wall of the tee conduit. The deflector includes a flange or diverter having other surface is disposed at a selected angle held within a conduit whereby a pressurized stream of water or other fluid or foam with or without cleaning additives, or a removable extendable and rotatable brush can be inserted into the sink drain line and deflected into the wall drain line creating a turbulent fluid flow (air or water) and/or physical scrubbing of the pipe drain line. Moreover, the deflector may be used for restricting or blocking a section of the pipe causing it to fill with fluid to aid in cleansing or exposing the top surface and side of the pipe with a cleaning fluid.

The access fitting or conduit is welded, glued, press fitted, or formed by molding into a short section of drain pipe such as the pipe having a 90 degree coupling or curved elbow section or portion extending from a short segment of pipe attachable to the upper distal end of the trap using a fitting, coupling, rubber hose, or boot. The distal end of the access fitting may include external threads for cooperatively engaging a hose coupling. A spray nozzle having a straight tip or an angled tip can be extended into the drain pipe and aimed at the deflector to squirt a stream of higher pressure water or cleaning solution on the interior surface of the drain pipe to remove accumulations of debris. The deflector guides a brush, stream of water, or cleaning solution into the wall drain pipe from the sink drain pipe to remove growth from the sides and top of the pipe near the junction of the sink drain pipe with the wall drain pipe or conduit connecting to the sewer line. A slidable and rotatable cable having a cleaning brush head may be inserted into the access spout as well.

In addition, a wire leader can be inserted into the conduit extending from the pipe coupling to until it hits the main line where it curves into the sewer or home waste water drain line. A selected portion of the leader may extend therein so that a drill can attach to the proximal end to rotate the wire and remove scum and debris from the walls of the tube near the junction of the sink drain line and main waste water line.

One preferred embodiment includes a drain pipe cleaning apparatus comprising an apparatus having a section of generally longitudinal pipe about six to eight inches long, with up to a ninety degree curved section such as a downward extending bend at the proximal end with a hand nut for temporary coupling said drain pipe to a sink trap. An access port or fitting such as a short segment of conduit or pipe can be affixed in fluid communication to the straight section of conduit above the trap, whereby the conduit includes a threaded fitting or friction fit removable cap for accessing the sink drain conduit prior to connection with the wall drain line. The apparatus will accommodate a cable with a coaxial longitudinal member, with a first end suitable for connection to a drill chuck and a second end suitable for scraping and tearing at a clog within a wall drain pipe.

It is an object of this invention to provide a pipe cleaner kit which includes a first temporarily connected insertable pipe segment including at least a section of curved pipe of a corresponding size to match a section of drain pipe whereby pressurized fluid or a retractable and rotatable brush of a selected diameter forms a coaxial fluid tight fit with a short segment of conduit extending from the insertable pipe segment providing means for sliding and rotating the pressurized fluid tube and nozzle within a sink drain pipe and contact a deflector to deliver a high pressure water or cleaning fluid or brush into the drain pipe within a wall.

It is an object of this invention to provide the above described pipe cleaner kit operable with a wire or cable which can be fed through the conduit and on into the wall drain pipe and can be plunged in and out and guided within the conduit. A drill can be attached to the proximal end of the wire or cable whereupon, the drill can cause the wire or cable to spin while the wore or cable is moved in and out of the conduit and into the drain pipe while the wire or cable is directed upward or downward by twisting and rotating the conduit left and right and in and out whereby the deflector directs the wire or cable into the connecting drain line in a wall leading to the sewer pipe.

It is another object of this invention to provide a pipe cleaner kit which includes a first drain pipe cleaning section which is used to temporarily replace the level pipe section following the trap, the first drain pipe section includes an offset access port had for insertion of a pressurized fluid or nozzle slidably and rotatably passing through a threaded sealable fitting into a conduit extending out of the first drain pipe cleaning section into the inlet of the main water drain pipe for cooperatively engaging a deflector at a selected angle of from one to ninety degrees allowing the pressurized fluid tube to be move in and out and swept upward and downward to clean the inside of the permanent drain pipe.

Other objects, features, and advantages of the invention will be apparent with the following detailed description taken in conjunction with the accompanying drawings showing a preferred embodiment of the invention.

### BRIEF DESCRIPTION OF THE DRAWINGS

A better understanding of the present invention will be had upon reference to the following description in conjunction with the accompanying drawings in which like numerals refer to like parts throughout the views wherein:

FIG. 1 is a perspective side view of a typical under sink plumbing arrangement showing a drain pipe from a sink connecting to a trap and a pipe leading therefrom to a septic line;

FIG. 2 is a perspective top view of a pipe cleaner apparatus for permanent or temporary installation to a trap unit under a sink showing a modified cleaning section having a deflector tee conduit inserted into the drain line having a cutaway section showing a deflector therein and showing an offset access fitting having a removable plug extending at a selected angle from the distal end of a downward extending elbow of a straight segment of conduit connecting the trap to the deflector tee conduit for insertion of a line cleaning means such as a retractable and rotatable brush and/or nozzle from a pressurized fluid line;

FIG. 3 is a perspective side view of the pipe cleaner apparatus of FIG. 2 for permanent or temporary installation to a trap unit under a sink showing a modified cleaning section having a deflector tee conduit inserted into the drain line having a cutaway section showing a solid wedge shaped deflector coaxially inserted therein and showing an offset access fitting having a removable plug extending at a selected angle from the distal end of a downward extending elbow of a straight segment of conduit connecting the trap to the deflector tee conduit for insertion of a line cleaning means such as a retractable and rotatable brush and/or nozzle from a pressurized fluid line;

FIG. 4 is a perspective top view of a pipe cleaner apparatus for permanent or temporary installation to a trap unit under a sink showing a modified cleaning section having a deflector tee conduit inserted into the drain line having a cutaway section showing a deflector therein and showing an offset access fitting having a removable plug extending at a selected angle from the distal end of a downward extending elbow of a straight segment of conduit connecting the trap to the deflector tee conduit for insertion of a line cleaning means such as a retractable and rotatable brush and/or nozzle from a pressurized fluid line;

FIG. 5 is a perspective cutaway top view of a 90 degree tee coupling showing a triangular deflector having straight side walls and having a back wall attaching to the inner back wall surface of the tee at the junction of the straight portion and the medial transverse portion;

FIG. 6 is a perspective cutaway top view of FIG. 3 showing a 90 degree tee coupling having a triangular deflector having inwardly curving side walls and having a back wall attaching to the inner back wall surface of the tee at the junction of the straight portion and the medial transverse portion;

FIG. 7 is a perspective cutaway top view of a 90 degree tee coupling showing an “L-shaped deflector having a short leg attaching to the inner back wall surface of the tee at the junction of the straight portion and the medial transverse portion centered and having an extended leg extending outward from the inner back wall surface of the tee at a right angle across the width of the elongated straight portion;

FIG. 8 is an end view of FIG. 4 showing the open end of the short leg of a 90 degree tee pipe coupling with an end view of a distal end of a “L-shaped deflector attaching to the inner back wall surface of the tee centered at the junction of the elongated straight portion and short medial transverse portion;

FIG. 9 is an end view of FIG. 4 showing the open end of the elongated straight portion of the 90 degree tee pipe coupling and showing a long leg of the “L-shaped deflector attaching to the inner back wall surface of the tee extending across the elongated straight portion toward the short medial transverse portion centered at the junction of the straight portion and medial transverse portion;

FIG. 10 is a perspective cutaway top view of a 90 degree tee coupling showing a rectangular shaped deflector pivotally attached by a hinge to the inner back wall surface of the tee at the junction of the straight portion and the medial transverse portion centered and extending straight outward from the inner back wall surface of the tee at a selected angle across the width of the elongated straight portion whereby pivoting of the deflector is limited to 45 degrees from the center line due to abutment with an inner sidewall of the medial transverse portion of the tee; and

FIG. 11 is a perspective cutaway top view of FIG. 7 showing a 90 degree tee coupling having a rectangular shaped deflector pivotally attached by a hinge to the inner back wall surface of the tee at the junction of the straight portion and the medial transverse portion centered and extending outward at a selected angle from the inner back wall surface of the tee at a selected angle across the width of the elongated straight portion whereby pivoting of the deflector is limited to 45 degrees from the center line due to abutment with an inner sidewall of the medial transverse portion of the tee.

### DESCRIPTION OF THE PREFERRED EMBODIMENTS

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the Figures. As used herein, the term “about” can be reasonably appreciated by a person skilled in the art to denote somewhat above or somewhat below the stated numerical value, to within a range of +10%.

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

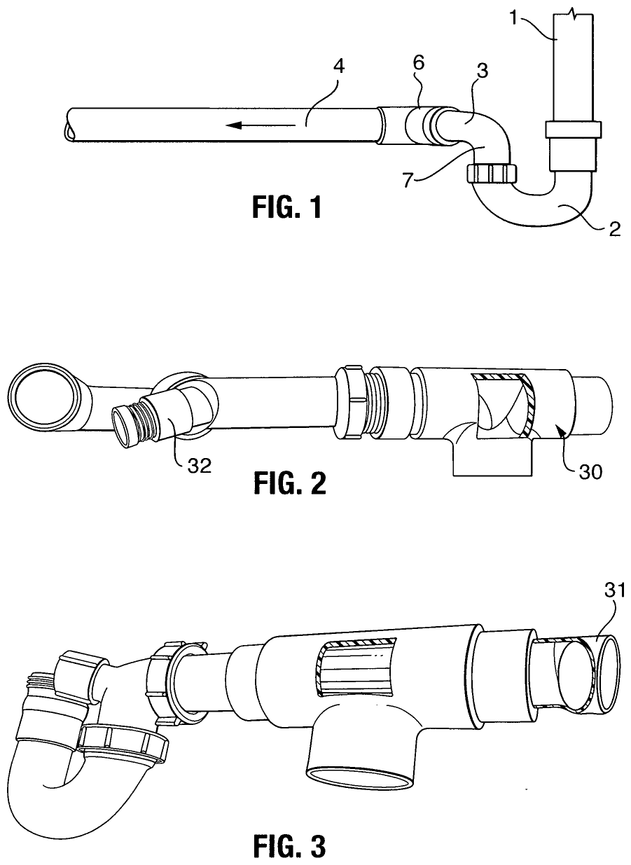

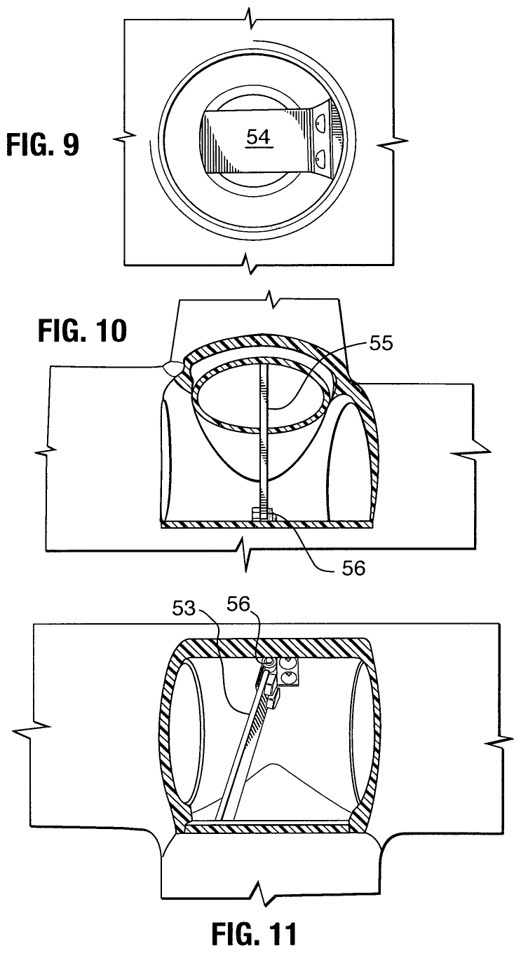

In accordance with the FIGS. 1-11, a typical under a sink plumbing arrangement is shown in FIG. 2. A sink drain (not shown) is connected to a vertical pipe 1. The vertical pipe is removably connected to the input end of a trap 2 using a hand nut. A generally longitudinal pipe 3 with a straight section and an elbow 7 is connected to the output end of the trap 2 at the elbow 7. The straight section of the of the pipe 3 is captured in an elbow 6 extending horizontally out of the wall. The elbow 6 is fixedly connected to a wall drain pipe 4. Normally, the wall drain pipe 4 is concealed from view by wall board with the elbow 6 extending out of the wall. The clog causing the complaint is caused by build up of slime, scum and algae growing on the inner top half of the wall drain pipe 4 and the elbow 6.

Attaching to the sink drain trap conduit 2, the drain pipe cleaning kit apparatus 10 comprises or consists of a modified access port section of a drain pipe conduit 28 having a distal end forming a downward extending curved section or elbow 31 having a 30 to 90 degree bend 31, and preferably a 90 degree bend for connecting to a distal end of the sing drain trap conduit coupled thereto with a first friction fit or threaded coupling with flange 20.

The elbow 31 has an offset or angled access port 32 to accept a brush, snake, or water wand or connect to a water line or other line for injecting water and/or soap or other detergent or other cleaning solution there through. The offset access fitting (spout or short conduit) has a removable plug 33 extending at a selected angle from the distal end of a downward extending elbow 31 of a straight segment of conduit 28 connecting to the trap 2 providing access to the conduit for insertion of a line cleaning means such as a retractable and rotatable brush and/or nozzle from a pressurized fluid line.

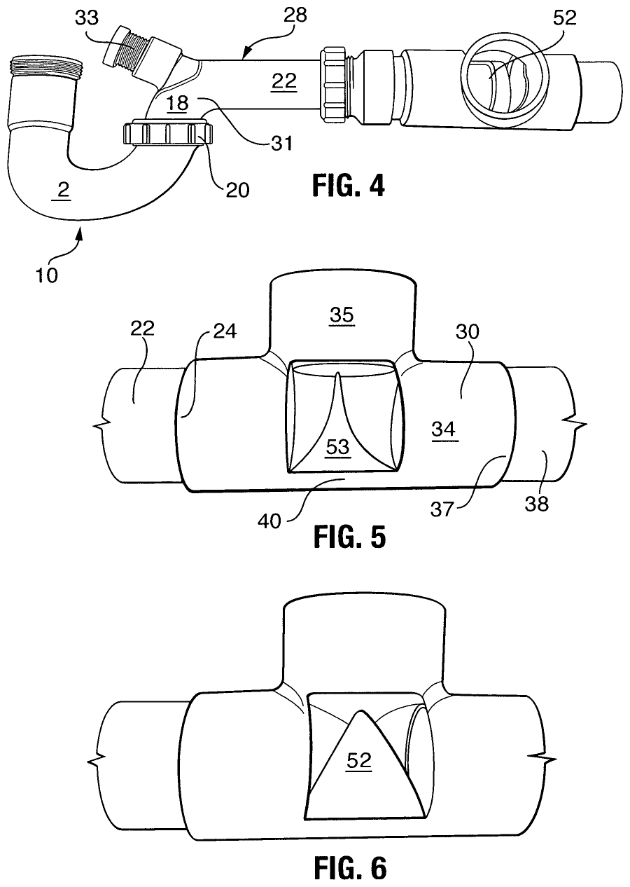

FIG. 4 shows a deflector tee conduit inserted into the drain line having an offset access fitting and a removable plug extending at a selected angle from the distal end of a downward extending elbow of a straight segment of conduit connecting the trap to the deflector tee conduit for insertion of a line cleaning means such as a retractable and rotatable brush and/or nozzle from a pressurized fluid line.

As shown the access port conduit 28 includes or is adapted to be connected to the drain pipe with threaded or friction fit couplings or clamps such as a hand nut 20 or flange for temporary coupling a distal end 18 of the drain pipe cleaning apparatus to the drain pipe and trap assembly. The proximal end of the conduit 22 includes a friction fit or threaded fluid sealable fitting including O-ring or compressible material for producing a water and/or air seal with a deflector tee conduit fitting 30.

Attached to the distal end of the conduit 28 opposite the trap is a tee conduit 30. The tee conduit 30 includes a straight section 34 having a proximate end 36 connecting to the distal end 22 of the access port conduit 28, a medial transverse conduit 35 centered and extending outward at a selected angle, typically a right angle (90 degrees) and a distal end 37 connecting to a wall conduit 38 from another sink or a in wall conduit leading to the sewer or septic or other waste discharge line.

FIGS. 3-11 show the 90 degree tee coupling 30 having a cutaway window 40 formed in a top section of the tee coupling conduit 34 in line with the transverse conduit 35 in order to show positioning of a deflector 51 attached by attachment means such as an adhesive, screws, friction fit, rivets, or combinations thereof an inner back wall surface 60 of the tee conduit 30 at the junction of the straight portion 34 and the medial transverse portion 35 centered and extending outward toward an opening 62 in a distal end 63 of the medial conduit 35 at a selected angle from the inner back wall surface 60 of the conduit tee at a selected angle across a selected width of the elongated straight portion 34 whereby the deflector deflects liquid of a wire, cable, brush, nozzle, or flow of fluid through the conduit 34 at an angle of up to 45 degrees.

As shown in FIG. 2, the pipe cleaner apparatus for permanent or temporary installation to a trap unit under a sink shows a modified cleaning section having a deflector tee conduit inserted into the drain line having a cutaway section showing a deflector 52 therein and showing an offset access fitting having a removable plug extending at a selected angle from the distal end of a downward extending elbow of a straight segment of conduit connecting the trap to the deflector tee conduit for insertion of a line cleaning means such as a retractable and rotatable brush and/or nozzle from a pressurized fluid line. In FIG. 3, a modified cleaning section has a deflector tee conduit having straight side edges inserted into the drain line having a cutaway section showing a solid wedge shaped deflector 52 coaxially inserted therein and showing an offset access fitting having a removable plug extending at a selected angle from the distal end of a downward extending elbow of a straight segment of conduit connecting the trap to the deflector tee conduit for insertion of a line cleaning means such as a retractable and rotatable brush and/or nozzle from a pressurized fluid line. As shown in FIG. 5, a 90 degree tee coupling comprises a triangular deflector 53 having inwardly curving forming a wedge and having a back wall attaching to the inner back wall surface of the tee at the junction of the straight portion and the medial transverse portion. In FIG. 6, a triangular deflector having straight side walls has a back wall attaching to the inner back wall surface of the tee at the junction of the straight portion and the medial transverse portion;

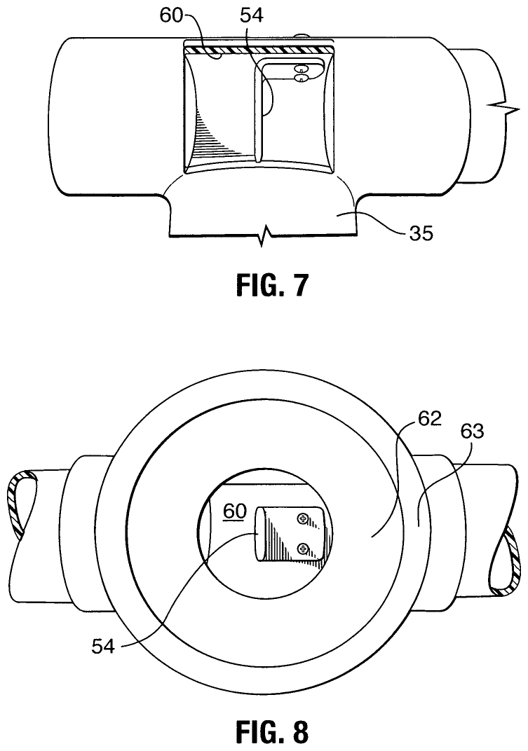

As best shown in FIGS. 7-9 shows an “L-shaped deflector 54 comprised of metal such as aluminum or steel or a plastic, fiberglass, or composite material such as graphite having a short leg attaching to the inner back wall surface of the tee at the junction of the straight portion and the medial transverse portion centered and having an extended leg extending outward from the inner back wall surface of the tee at a right angle across the width of the elongated straight portion.

A rectangular shaped deflector 55 is pivotally attached by a hinge 56 to the inner back wall surface of the tee at the junction of the straight portion and the medial transverse portion centered and extending straight outward from the inner back wall surface of the tee at a selected angle across the width of the elongated straight portion whereby pivoting of the deflector is limited to 45 degrees from the center line due to abutment with an inner sidewall of the medial transverse portion of the tee as shown in FIGS. 10-11.

Method of Use

As shown in figures, the cleaning section insert is used to replace a section of the pipe trap and the drain pipe. The coaxial longitudinal member 22 can be pushed in and out and twisted up and down to aim the open end 24 of the coaxial longitudinal member within the elbow 6 and the connected end of the wall drain pipe 4.

An alternative use for the tool 10 is provided by removing the manual valve from the proximal end of the coaxial longitudinal member and inserting the cable 16 into the proximal end of the coaxial longitudinal member 22, inserting the scraping end, abraded or grooved tip or flanged tip 42 as shown in FIG. 5. The cable 16 is pushed into the coaxial longitudinal member until a few inches extend out of the distal end 24 of the coaxial longitudinal member 22. The cable 16 can be moved in and out, or twisted left and right while the coaxial longitudinal member 22 is moved in and out and rotated directing the tip up or down. Further, the proximal end 40 of the cable 16 can be chucked into a drill and the drill can spin the cable within the pipes to help dislodge the clog.

A hollow tube or rod for holding pressurized fluid and having an external diameter less than the internal diameter of the access coupling is rotatably and slidably coaxially held within the offset access coupling. The hollow tube, rod, or cable or lead wire, collectively referred to as “coaxial longitudinal member” coaxially inserted into the offset access port can be used for delivering high pressure water or cleaning solution into the coupling or a rotatable and slidable rod, wire, or cable.

More particularly, the distal end of the coaxial longitudinal member comprising a hollow tube or hollow rod can use a curved distal end or tip inserted at a selected angle or up to 90 degrees bent forming an amiable output which extends outward from the top inner surface of the distal end of the drain pipe and extends outward from the proximal end used to twist the coaxial longitudinal member when desired to direct the pressurized fluid flow against the debris accumulated on the inside of the drain pipe. The kit may also include a wire or cable with a first end suitable for connection to a drill chuck and a second end comprising a selected tip such as a grooved tip, enlarged tip, hollow tip, tip including external threads formed axial to, at an angle to or normal to the axis suitable for scraping and tearing at a clog within a wall drain pipe. It is also contemplated that a camera lens tip connected to a fiber optic cable can be threaded through the conduit in order to examine the conduit.

The foregoing detailed description is given primarily for clearness of understanding and no unnecessary limitations are to be understood therefrom, for modification will become obvious to those skilled in the art upon reading this disclosure and may be made without departing from the spirit of the invention and scope of the appended claims. Accordingly, this invention is not intended to be limited by the specific exemplification presented herein above. Rather, what is intended to be covered is within the spirit and scope of the appended claims.

I claim:

1. A drain pipe cleaning apparatus comprising:
an access conduit for attachment to distal end of a trap conduit, said off access conduit including an offset access port including a removable plug and a straight section extending at a selected angle from a downward extending elbow;
said access conduit including a straight distal end portion attaching to a tee conduit;
said tee conduit having a straight section and a medial perpendicular section and including a deflector disposed within said tee conduit attaching to an inner wall surface opposite said medial perpendicular section by attachment means; and
said deflector deflecting means for cleaning in said conduit at an angle of up to 90 degrees;
said tee conduit including a distal end coupling to a drain discharge conduit.

2. The drain pipe cleaning apparatus of claim 1, wherein said means for cleaning is a pressurized fluid.

3. The drain pipe cleaning apparatus of claim 1, wherein said means for cleaning is a cable having a cleaning head extending through said access conduit and said tee conduit past said deflector.

4. The drain pipe cleaning apparatus of claim 1, wherein said deflector comprises a wedge having straight deflector side edges.

5. The drain pipe cleaning apparatus of claim 1, wherein said coupling segment extending from said cleaning drain pipe section including a fluid tight sealed fitting for removably connecting a valve for controlling delivering of a high pressure fluid through said coaxial longitudinal member.

6. The drain pipe cleaning apparatus of claim 1, wherein said deflector comprises a wedge having inwardly curved deflector side edges.

7. The drain pipe cleaning apparatus of claim 1, wherein said deflector comprises a L-shaped strip of material.

7. The drain pipe cleaning apparatus of claim 1, wherein said deflector comprises a L-shaped strip of material pivotally attaching to an inner surface of said tee conduit opposite an opening in said medial conduit.

8. A drain pipe cleaning kit comprising:
an access conduit for attachment to distal end of a trap conduit, said off access conduit including an offset access port including a removable plug and a straight section extending at a selected angle from a downward extending elbow;
said access conduit including a straight distal end portion attaching to a tee conduit;
said tee conduit having a straight section and a medial perpendicular section and including a deflector disposed within said tee conduit attaching to an inner wall surface opposite said medial perpendicular section by attachment means;
said deflector deflecting means for cleaning in said conduit at an angle of up to 90 degrees; and
said tee conduit including a distal end coupling to a drain discharge conduit.
